(19) United States
(12) Patent Application Publication
(10) Pub. No.: US 2017/0286890 A1
(43) Pub. Date: Oct. 5, 2017

(54) Method for Arranging and Managing Employment Contracts

(71) Applicant: Thomas J. Fuessel, JR., Mokena, IL (US)

(72) Inventor: Thomas J. Fuessel, JR., Mokena, IL (US)

(21) Appl. No.: 15/476,433

(22) Filed: Mar. 31, 2017

Related U.S. Application Data
(60) Provisional application No. 62/316,789, filed on Apr. 1, 2016.

(51) Int. Cl. G06Q 10/06; G06Q 10/10; G06Q 30/06

(52) U.S. Cl. CPC G06Q 10/063116; G06Q 30/0645; G06Q 10/1053

(57) ABSTRACT

A method for arranging and managing employment contracts that is carried out through a software application operated on a plurality of personal computing devices and a back-end system. A contract request is sent from a contractor account to the back-end system in order to seek the employment of a skilled worker associated with a worker account. The contract request is accepted or declined through the worker account; if accepted, a live worker calendar is updated with a project timeline, wherein the days of the project timeline are marked as unavailable dates on the live worker calendar. Once a project is completed, the contractor may provide a review of the skilled worker through the contractor account, while the skilled worker may provide a review of the contractor through the worker account.

The current application claims a priority to the U.S. Provisional Patent application Ser. No. 62/316,789 filed on Apr. 1, 2016.

### FIELD OF THE INVENTION

The present invention relates generally to temporary employment contracts. More specifically, the present invention is a method for arranging and managing employment contracts between trade workers and trade contractors.

### Background of the Invention

Trade workers give up a lot of income working through a temporary employment agency, as the agency makes a profit on the hourly worker. Meanwhile, as a contractor, it is a constant struggle to maintain a skilled workforce. Projects would end and new projects would not start right away. Contractors are forced to lay-off their skilled workers and then hope that the workers were available to work on their next project. A service that trade workers could take temporary work until other projects started is ideal. Trade workers often find themselves in the same position. Projects end, and trade workers may lose several weeks of employment while they wait for a new project to begin.

Therefore, it is an object of the present invention to help trade workers make more money more efficiently. The present invention is a robust on-line subscription based software system built to match trade workers with trade contractors. Through a detailed entry system, the present invention will develop a database of trade workers and trade contractors. The present invention will allow automatic interaction to a “live” calendar. Trade workers will be able to create their schedule on their personal page and submit the schedule to the live calendar for review and acceptance by contractors. Contractors will be able to input project information and select from a filtered group of trade worker candidates that meet their project specifications and have been rated by the work they have done. The calendar is fully automated and updated with each transaction.

Trade workers will not have to constantly call for employment. Trade workers will be able to create their own schedule and can count on the present invention to constantly look for employment opportunities for them. Contractors will always have a pool of trade workers to draw from. If a contractor has only weekend work, there will be trade workers willing and able to meet your needs. The present invention provides trade workers with the opportunity to open up their weekend schedule prior to the holidays or a family vacation. Trade workers have the opportunity to make more money to enjoy their days off. Trade workers that are carpenters, electricians, laborers, millwrights, painters, pipe fitters, plasterers, plumbers, roofers, sheet metal workers, etc. would benefit greatly from the present invention.

In summary, the present invention allows trade workers to be asked which dates that they are not available (i.e. “Black-out” dates) and consequently allows contractors to target the open dates that those trade workers are available.

### BRIEF DESCRIPTION OF THE DRAWINGS

FIG. 1 is a diagram depicting the back-end system communicating with the plurality of personal computing devices across the wide area network.

FIG. 2 is a diagram of the live worker calendar, wherein available dates are differentiated from unavailable dates.

FIG. 3 is a diagram of the live contractor calendar, wherein the employment of a skilled worker for a project is indicated.

FIG. 4 is a flowchart depicting the steps for scheduling employment between a contractor and a skilled worker.

FIG. 5 is a flowchart thereof, further depicting steps for the registration of the skilled worker.

FIG. 6 is a flowchart thereof, further depicting steps for the registration of the contractor.

FIG. 7 is a flowchart thereof, further depicting steps for determining the available worker accounts for a project.

FIG. 8 is a flowchart thereof, further depicting steps for indicating available dates and unavailable dates on the live worker calendar.

FIG. 9 is a flowchart thereof, further depicting steps for scheduling a project on the live worker calendar.

FIG. 10 is a flowchart thereof, further depicting steps for notifying the skilled worker of the contract request.

FIG. 11 is a flowchart thereof, further depicting steps for providing a review of the contractor and the skilled worker.

FIG. 12 is a flowchart thereof, further depicting steps for renting equipment to contractors or skilled workers.

### DETAIL DESCRIPTIONS OF THE INVENTION

All illustrations of the drawings are for the purpose of describing selected versions of the present invention and are not intended to limit the scope of the present invention.

The present invention is a method for arranging and managing employment contracts that is carried out through a software application operated on a plurality of personal computing devices and a back-end system. The present invention allows a skilled worker to create a worker profile that includes work locations, skills, experience, pay rate, etc. for the skilled worker. Contractors can then search through a database of skilled workers to find skilled workers in the same location and that have the desired skills, experience, pay rate, etc. The present invention facilitates the scheduling of the project timelines by automatically updating contractor schedules and worker schedules when a skilled worker is hired.

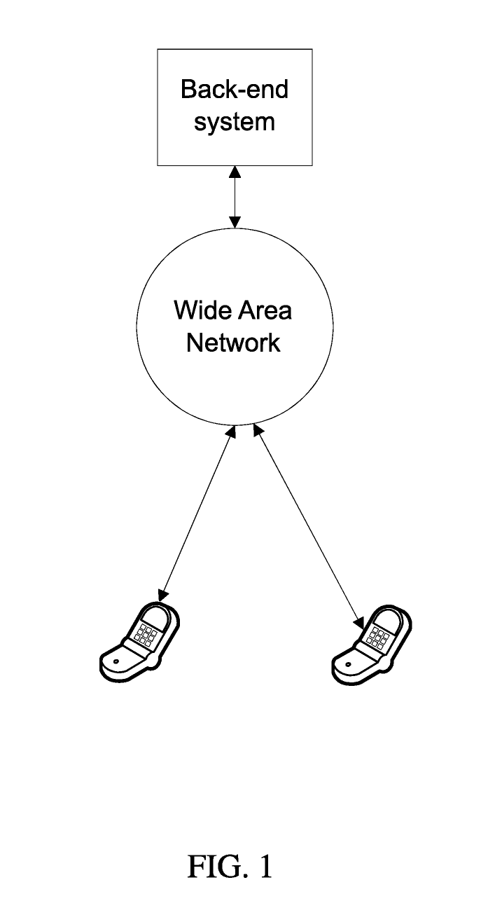

In reference to FIG. 1, the back-end system includes one or more servers and networking devices to allow communication across a wide area network, either through a wired connection or wireless connection. Each of the plurality of personal computing devices is a computer that is capable of connecting to the wide area network in order to communicate with the back-end system. The back-end system may fully host the software application, such as in the form of a web site, or the software application may be hosted by both the back-end system and each of the plurality of personal computing devices, such as in the form of a downloadable application that communicates with a back-end application.

When first accessing the software application, either as a webpage or downloadable application, a user (either contractor or skilled worker) is directed to a home page. The home page displays a logo, a description of services, legal terms and conditions, vendor advertisement, and the option to select whether the user is a contractor or a skilled worker. If the user already has a registered account, then the user can sign in to an existing contractor or worker account. If the user does not have a registered account, the user must first register as either a contractor or a skilled worker in order to utilize the employment features offered by the software application.

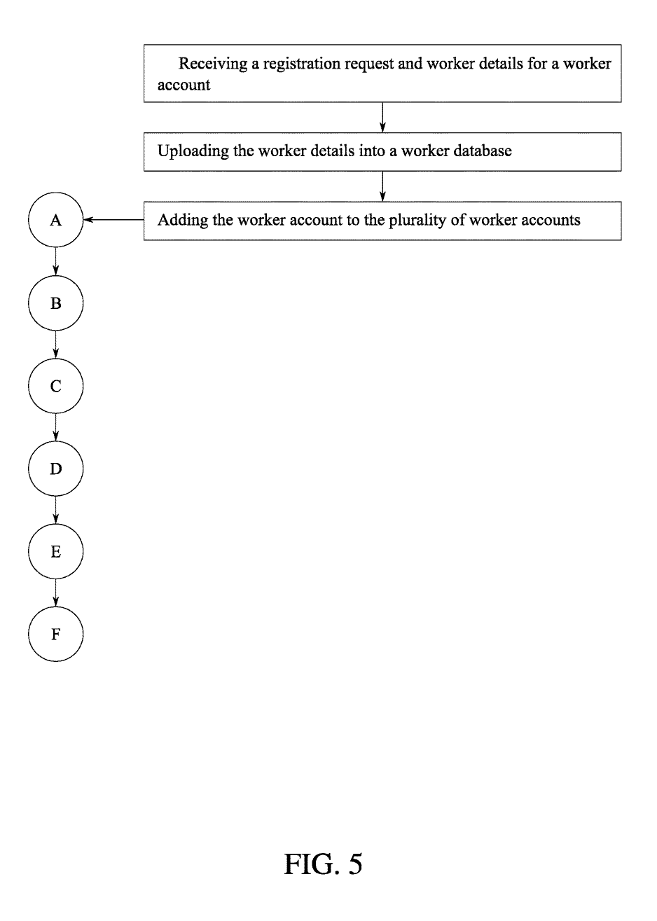

In reference to FIG. 5, in order to utilize the employment features of the software application, a skilled worker must first register with and be approved by a software application host. The skilled worker submits information to the software application host through a webpage interface, dedicated application interface, or other suitable means. The information submitted by the skilled worker may include, but is not limited to, personal details (e.g. name, age, phone number, address, etc.), a bio, trade(s)/skill(s), experience/qualifications, pay rate, and work location(s). A background check of the skilled worker and the information submitted by the skilled worker is then performed by the software application host.

If the skilled worker is deemed ineligible by the software application host, then the skilled worker is notified via email, short message service (SMS), or other suitable means that access to the software application has not been granted; the reason for ineligibility may or may not be included in the notification. If the skilled worker is deemed eligible by the software application host following the background check, then the information submitted by the skilled worker is uploaded into a worker database and a worker account is created for the skilled worker. Additionally, a temporary username and a temporary password are sent to the skilled worker. The temporary username and the temporary password can be sent to the skilled worker via email, SMS, or other suitable means.

Once authorized by the software application host, the skilled worker can log into the worker account using the temporary username and the temporary password. Upon signing into the worker account, the software application prompts the skilled worker to replace the temporary username and the temporary password with a permanent username and a permanent password, respectively. The skilled worker then enters the permanent username and the permanent password through the worker account, wherein the permanent username and the permanent password are stored by the back-end system. Furthermore, once authorized by the software application host, the worker account is added to a plurality of worker accounts stored in the worker database.

The skilled worker is then prompted to select, or enter, the skills that are to be listed and what trade pages the skilled worker wants to be listed on. Some or all of the information may be auto populated using the data collected during the registration process described above, or the skilled worker may be required to manually re-enter the information. The skilled worker is also prompted to input a work region in order to indicate a general location in which the skilled worker would like to accept job offers. The work region could be input as a zip code, county, state, radius from a business headquarters, etc. The work region is utilized to match the skilled worker with contractors having projects in the same location.

The following provides an exemplary process for submitting worker information to create a profile page for the skilled worker: a) Select trade; b) Select trade level (e.g. apprentice, journeymen, foreman, general foreman, superintendent); c) Select trade experience (e.g. years); d) Select trade specifics (e.g. industrial, commercial, residential, service, maintenance); e) Select counties; f) Select restrictions (e.g. no high work, no ladder work, no tower work, no outside heat, no outside cold, etc.); g) Working rate (e.g. $10-$15 per hour, $16-20 per hour, $21-$25 per hour, $26-$30 per hour, $31-$35 per hour, $36-$40 per hour, $40-$45 per hour, $46-$50 per hour, $51-$55 per hour). Workers are encouraged to select a rate that is reasonable for the trade and experience as higher rates may discourage contractors; h) Input additional information about experience (e.g. type 200 words or less; projects worked on, specialties).

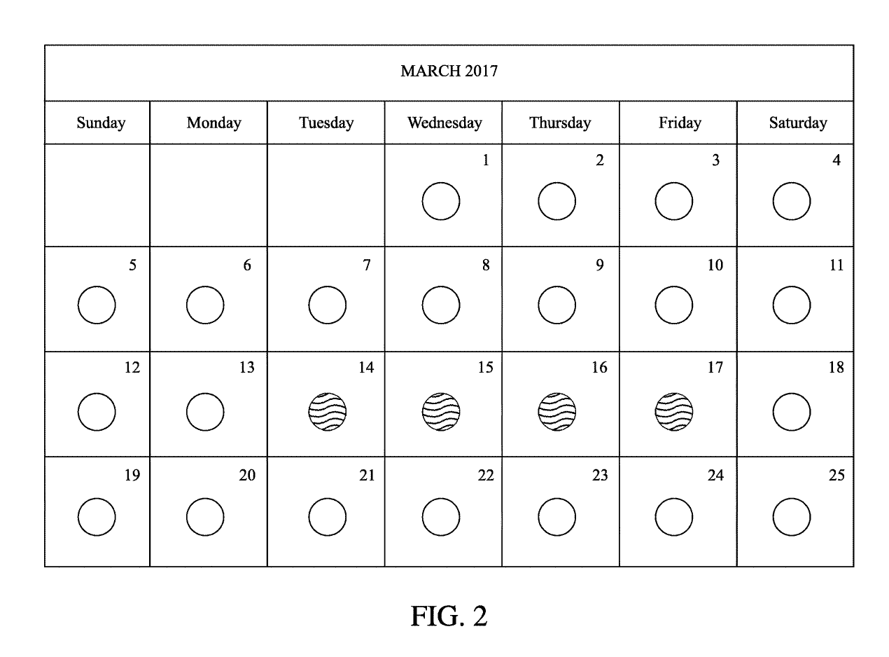

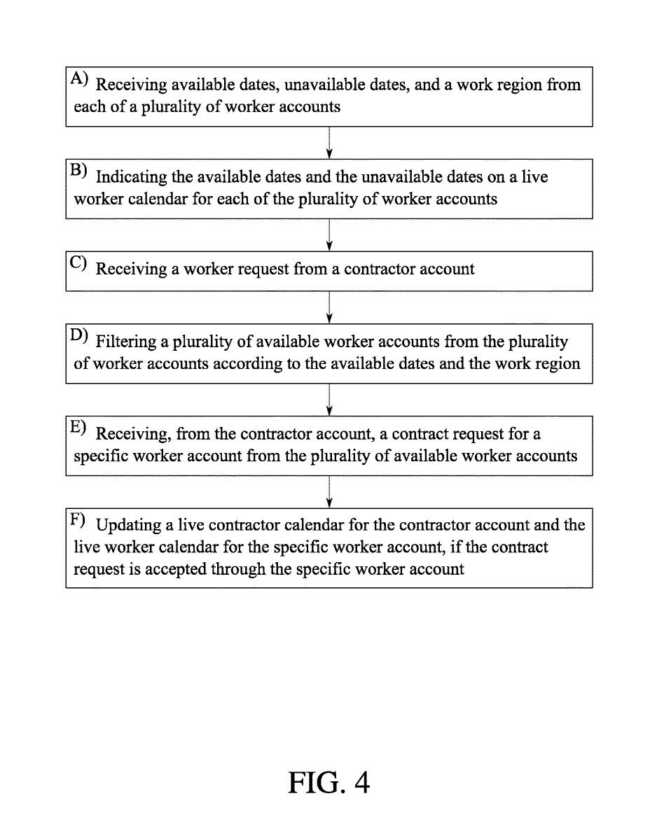

In reference to FIG. 4, once the profile page has been submitted, the skilled worker is prompted to enter available dates and unavailable dates through the worker account. The available dates indicate a day and/or time that the skilled worker is willing to accept a job request. Meanwhile, the unavailable dates indicate a day and/or time that the skilled worker is not willing to accept a job request. The back-end system receives the available dates and the unavailable dates through the worker account and generates a live worker calendar for the skilled worker, as depicted in FIG. 2. The live worker calendar can be viewed through the worker account, wherein the live worker calendar graphically indicates the available dates and the unavailable dates using a designated color scheme. The skilled worker can update the live worker calendar at any time by accessing a “My Calendar” page through the worker account.

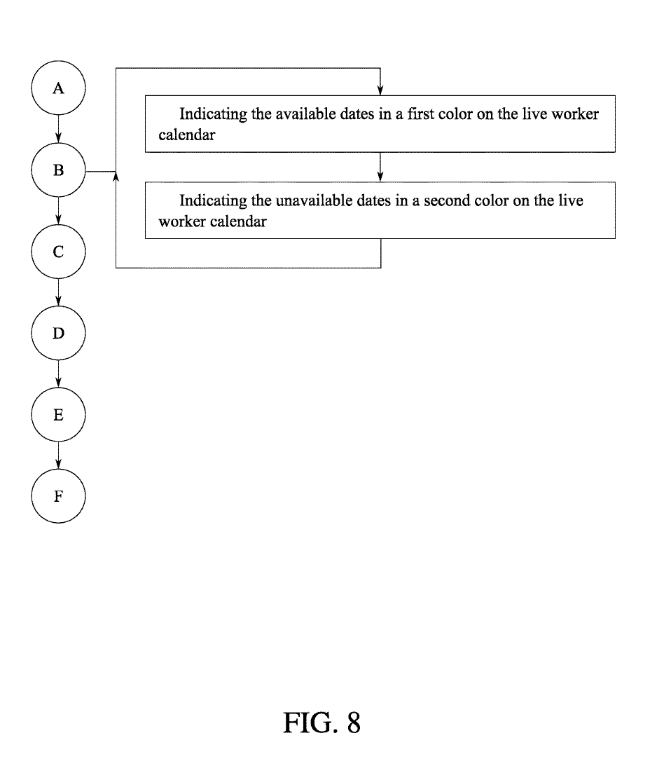

In reference to FIG. 2 and FIG. 8, the back-end system indicates the available dates in a first color and the unavailable dates in a second color. This provides a visible discernibleness between the available dates and the unavailable dates, allowing the skilled worker to readily view and modify the live worker calendar. In the preferred embodiment of the present invention, the first color used for each of the unavailable dates is black, while the second color used for each of the available dates is white. In other embodiments, the first color and the second color may be another combination of distinct colors. The following provides an exemplary process for updating the live worker calendar: a. Click on “My Calendar”; b) Select days not available to work (days will be “blacked” out on live worker calendar); c) Days available will be clear; d) Live worker calendar saved on the back-end system and displayed to contractors.

The unavailable dates, or “black-out” dates, can be other project commitments, personal time, medical appointments, vacation time, etc. The live worker calendar makes it more comfortable for the skilled worker when the skilled worker is employed, as the skilled worker does not have to worry about breaking the news to the contractor, since the contractor can already view future dates that the skilled worker is not available.

The skilled worker can update the worker information on the profile page at any time by clicking on an “Edit Profile” button on the live worker calendar. Alternatively, the “Edit Profile” button may be located on a different page. Once the “Edit Profile” button is selected, the profile page of the skilled worker is opened, wherein the skilled worker can select the worker information to update (e.g. selecting the desired drop down field, re-entering data, etc.). When the new information is entered into the profile page, the back-end system saves the new information. Once the skilled worker has made the desired changes to the worker information, the skilled worker can click a “Done Editing” button, wherein the profile page is closed.

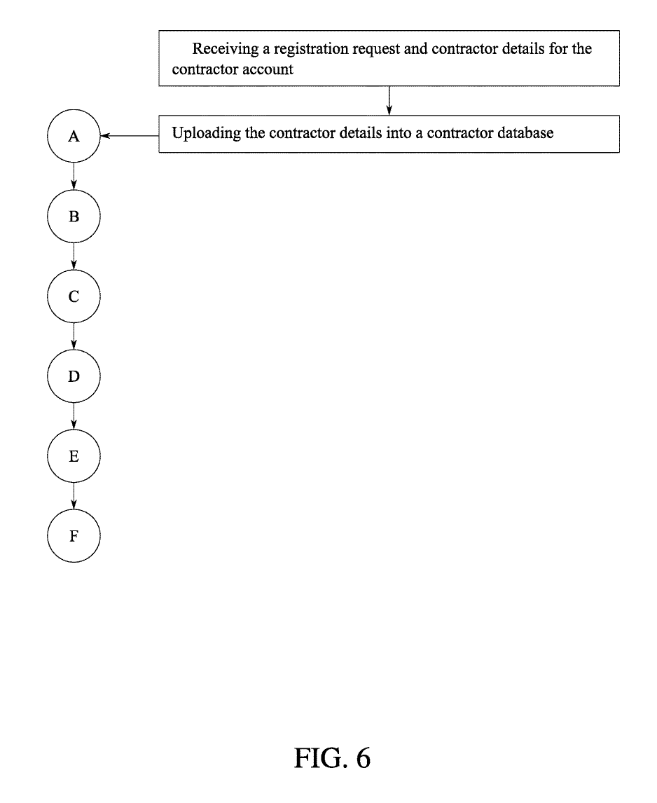

In reference to FIG. 6, similar to the skilled worker, in order to utilize the employment features of the software application, a contractor must first register with and be approved by the software application host. The contractor submits information to the software application host through a webpage interface, dedicated application interface, or other suitable means. The information submitted by the contractor may include, but is not limited to, personal details (e.g. name, age, phone number, address, etc.), company details (e.g. company name, company description, etc.), areas of service, experience, and proof of insurance including workers' compensation and general liability. A background check of the contractor and the information submitted by the contractor is then performed by the software application host.

If the contractor is deemed ineligible by the software application host, then the contractor is notified via email, short message service (SMS), or other suitable means that access to the software application has not been granted; the reason for ineligibility may or may not be included in the notification. If the contractor is deemed eligible by the software application host following the background check, then the information submitted by the contractor is uploaded into a contractor database and a contractor account is created for the contractor. Additionally, a temporary username and a temporary password are sent to the contractor. The temporary username and the temporary password for the contractor can be sent to the contractor via email, SMS, or other suitable means.

Once authorized by the software application host, the contractor can log into the contractor account using the temporary username and the temporary password provided to the contractor. Upon signing into the contractor account, the software application prompts the contractor to replace the temporary username and the temporary password with a permanent username and a permanent password, respectively. The contractor then enters the permanent username and the permanent password through the contractor account, wherein the permanent username and the permanent password of the contractor are stored by the back-end system.

The contractor is then prompted to select a project timeline on a live contractor calendar and enter project details including, but not limited to, a project location, the number of skilled workers needed, the skills required by each of the skilled workers, and a desired payrate for each of the skilled workers. The following is an exemplary process of entering project details by the contractor: a) Select days that trade workers are needed; b) Select the number of trade workers needed; c) Select the trade level of the trade workers (apprentice, journeymen, foreman, general foreman, superintendent); d) Select trade specifics (industrial, commercial, residential, service, maintenance); e) Select county where work is to be performed; f) Select requirements (high work, ladder work, tower work, outside heat, outside cold, etc.); g) Working rate (e.g. $10-$15 per hour, $16-20 per hour, $21-$25 per hour, $26-$30 per hour, $31-$35 per hour, $36-$40 per hour, $40-$45 per hour, $46-$50 per hour, $51-$55 per hour). Select the working rate. All trade workers at that rate and below that are available will be identified.

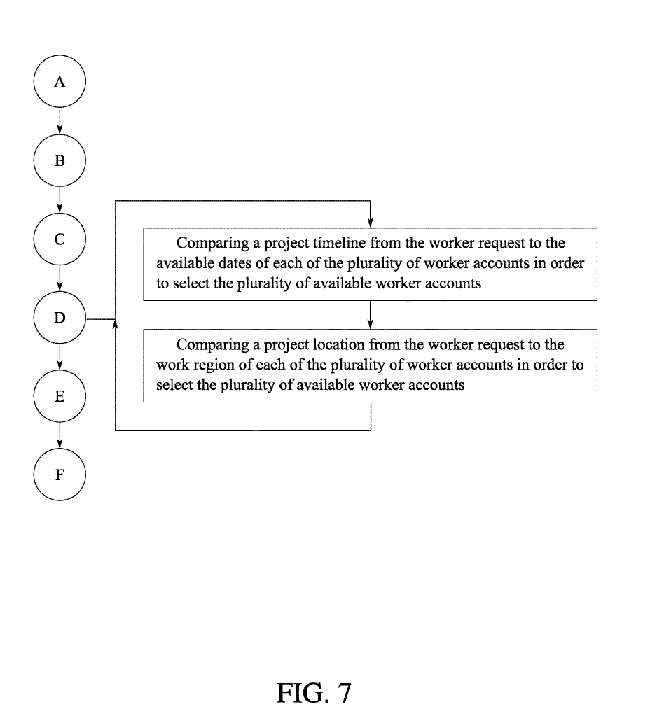

The project timeline and the project details are formed into a worker request by the back-end system, wherein the back-end system searches through the plurality of worker accounts stored in the worker database. In reference to FIG. 7, the back-end system compares the project timeline to the available dates of each of the plurality of worker accounts, and compares the project location to the work region of each of the plurality of worker accounts. Furthermore, requirements set by the contractor are compared to restrictions of each of the skilled workers in order to further narrow the worker selection pool.

If the available dates coincide with the project timeline, and the project location is within the work region, then the corresponding worker account is pulled from the plurality of worker accounts. In reference to FIG. 4, the process is repeated for each of the plurality of worker accounts listed in the worker database in order to filter a plurality of available worker accounts from the plurality of worker accounts. A summary of each of the plurality of available worker accounts is then displayed through the contractor account, wherein the contractor can select the desired skilled worker(s). The contractor can select a specific worker account from the plurality of available worker accounts in order to view a profile page of specific worker account, showing the full details of the skilled worker.

If the contractor wants to hire the skilled worker associated with the specific worker account, then the contractor can send a contract request for the specific worker account. In the preferred embodiment, the contract request is initiated by clicking a “Hire Me” button, or link, on the profile page of the specific worker account. If the contractor does not want to select the skilled worker, then the contractor can click a “No Thanks” button, or link, wherein the contract request is not sent and the contractor is returned to the summary of the plurality of available worker accounts in order to select another worker.

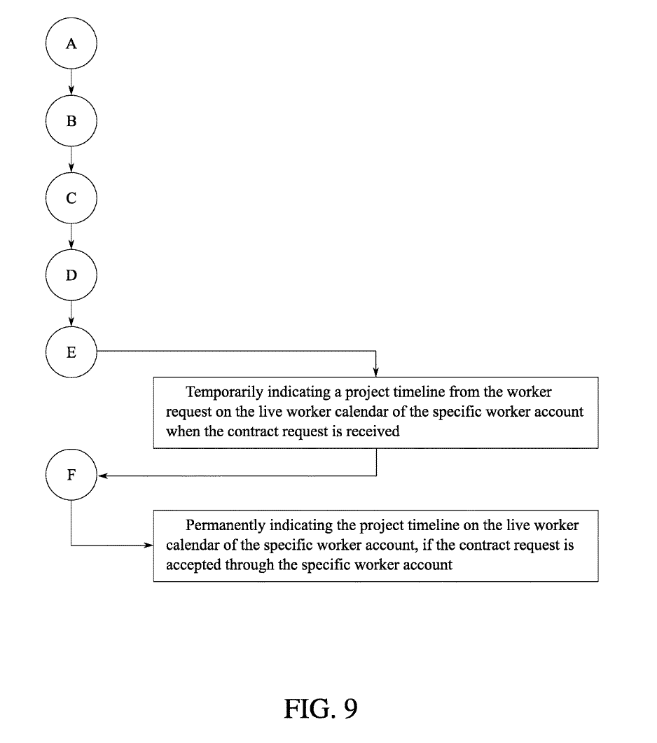

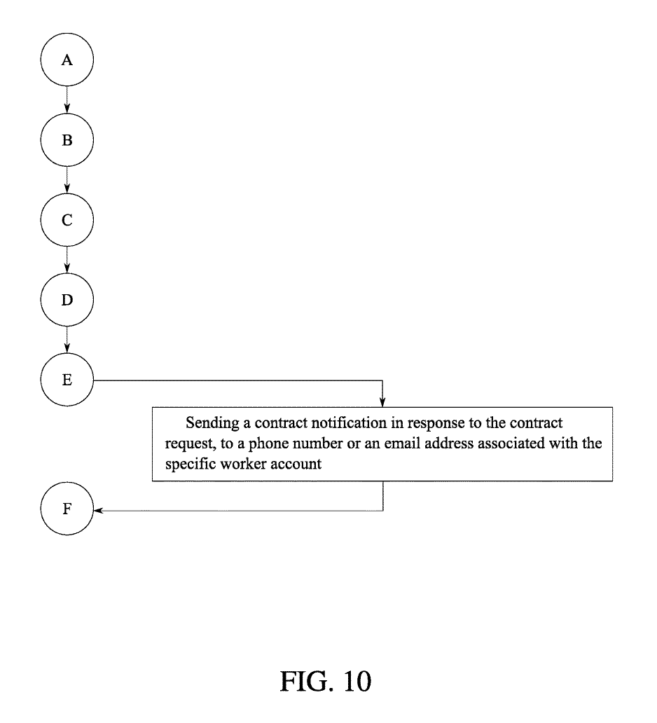

In reference to FIG. 10, when the contract request is received by the back-end system, the back-end system sends a contract notification to the skilled worker associated with the specific user account. The contract notification can be sent via SMS to a phone number associated with the specific worker account, via email to an email address associated with the specific worker account, or by another suitable means of communication. In reference to FIG. 9, in addition to sending the contract notification, the back-end system updates the live worker calendar of the specific worker account by temporarily indicating the project timeline from the worker request on the live worker calendar of the specific worker account. In the preferred embodiment, the dates for the project timeline are indicated in a third color, yellow, on the live worker calendar of the specific worker account.

The skilled worker can respond to the contract request by accepting or declining the contract request through the specific user account. In reference to FIG. 4, if the skilled worker accepts the contract request, then the back-end system updates the live worker calendar of the specific worker account by permanently indicating the project timeline on the live worker calendar of the specific worker account. In the preferred embodiment, the dates for the project timeline are changed from the third color to a fourth color (yellow to green), when the contract request is accepted through the specific worker account.

The following is an exemplary process of accepting the contract request by the skilled worker: a) Receive a text message that includes a county, type of work, days to work, and wage rate; b) Enter “Hire Me” or “Sorry Not Available”, or select “Hire Me” or “Sorry Not Available” from the live worker calendar. The days desired by the contractor will appear yellow on the live worker calendar; c) Select “Hire Me” and a text will come up to ask for subscription payment (3 months minimum and drawn on at monthly intervals). Must be a valid credit card for processing; d) Input credit card information and select “I have read terms and conditions”; e) Application to be hired will be sent to the contractor. Keep in mind that the contractor may have sent out multiple offers to candidates, so must respond quickly; f) Notification will be sent to the skilled worker, if response has been accepted; g) Go to the live worker calendar to view the dates hired which are indicated on the live worker calendar in green; h) Click on the green dates to see the detailed information that includes; contact information. Call the contact number and begin working.

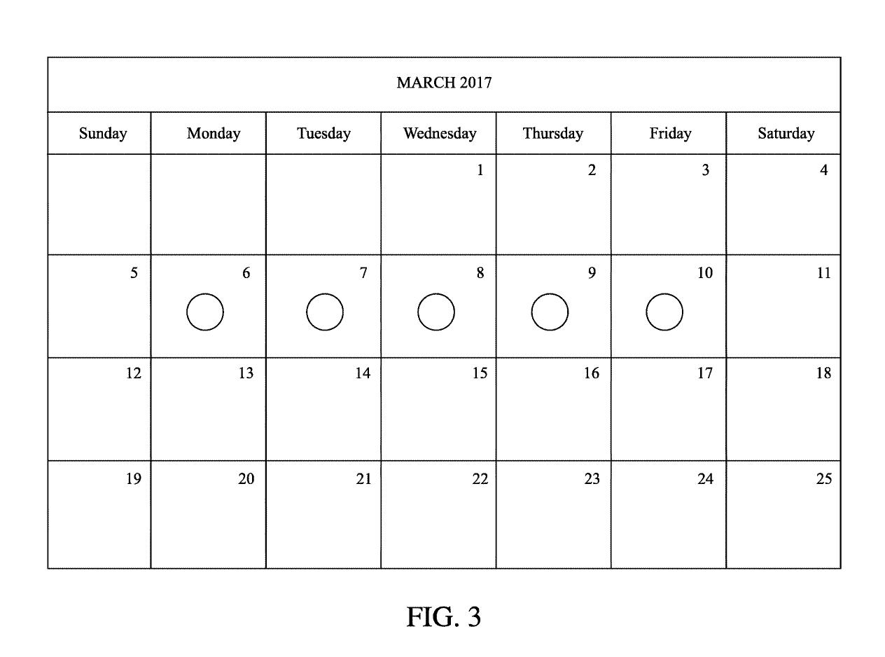

The contractor will receive either an “Accepted” text if the skilled worker accepts the contract request or a “Sorry not available” text if the skilled worker declines the contract request. If the skilled worker accepts the contract request, then a text will come up to ask for subscription payment (1-year minimum and drawn on at monthly intervals); must be a valid credit card for processing. The contractor then inputs credit card information and selects “I have read the terms and conditions. In reference to FIG. 4, the back-end system then updates the live contractor calendar by displaying the name of the skilled worker on the live contractor calendar for the duration of the project timeline, as depicted by FIG. 3. The contractor can select the name of the skilled worker from the live contractor calendar in order to view the full details and contact information of the skilled worker.

If the project is extended, then the contractor should let the skilled worker know so the skilled worker can update the live worker calendar. Similarly, the contractor should let the skilled worker know if the project will end early, so the skilled worker can update the live worker calendar. Failure to update skilled worker can result in negative feedback for the contractor. While the contractor should notify the skilled worker of timeline changes, the skilled worker has a personal responsibility to update the live worker calendar as appropriate. For example, if the project is extended, then the skilled worker should indicate on the live worker calendar the unavailable dates as described above in order to update the live worker calendar; if the project extension conflicts with another scheduled project, then the appropriate contractor is notified to find another skilled worker. If the project ends early, then the skilled worker can select the available dates on the live worker calendar, wherein the days are switched from green to white. Failure to update the live worker calendar may result in automatic negative feedback for the specific worker account.

For projects with an indefinite timeline, there is an indefinite hire option that can be selected when sending the contract request. When the indefinite hire option is selected, each weekday is marked as unavailable for the foreseeable future. However, the skilled worker is presented with an option to be available on weekends. If the skilled worker selects to be available on weekends, then the live worker calendar will leave those days open. If the skilled worker selects to be unavailable on the weekends, then the live worker calendar will mark those days as unavailable.

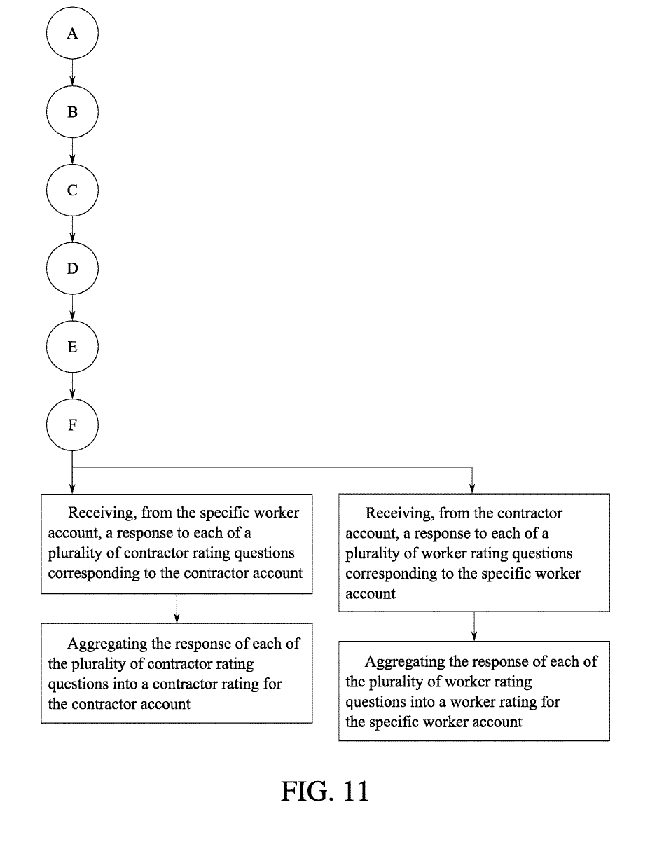

In reference to FIG. 11, once the project has been completed, the skilled worker and the contractor are given the opportunity to rate each other. The skilled worker is presented with a plurality of contractor rating questions; the plurality of contractor rating questions being a set of standardized, weighted questions. The back-end system receives a response to each of the plurality of contractor rating questions from the specific worker account. The back-end system then aggregates the response to each of the plurality of contractor rating questions into a contractor rating for the contractor account. The contractor rating is then aggregated with ratings from the skilled workers of previous projects to form an overall contractor rating. The overall contractor rating is displayed on the profile page of the contractor and can be viewed when contract requests are sent to future skilled workers, such that the future skilled workers may utilize the overall contractor rating in determining whether or not to accept the contract offer.

The contractor review may be initiated by the skilled worker by clicking on a project review button. The skilled worker can then select the desired contractor to review, if the skilled worker was employed on more than one contract. In the preferred embodiment of the present invention, the skilled worker can give a rating of 1-5 as the response to each of the plurality of contractor rating questions. The skilled worker selects the desired value for each of the plurality of contractor rating questions, wherein the values are aggregated to generate the contractor rating being a value from 1-5. After answering each of the plurality of contractor rating questions, the skilled worker clicks a submit review button, wherein the contractor review is finalized and saved by the back-end system.

In reference to FIG. 11, similar to the skilled worker, the contractor is presented with a plurality of worker rating questions; the plurality of worker rating questions being a set of standardized, weighted questions. The back-end system receives a response to each of the plurality of worker rating questions from the contractor account. The back-end system then aggregates the response of each of the plurality of worker rating questions into a worker rating for the specific worker account. The worker rating is then aggregated with ratings from the contractors of previous projects to form an overall worker rating. The overall worker rating is displayed on the profile page of the skilled worker and in the summary of the plurality of available worker accounts, such that future contractors may utilize the overall worker rating in determining whether or not to send the contract request to the skilled worker.

The worker review may be initiated by the contractor by clicking on a project review button. The contractor can then select the desired skilled worker to review, if the contractor employed more than one skilled worker. In the preferred embodiment of the present invention, the contractor can give a rating of 1-5 as the response to each of the plurality of worker rating questions. The contractor selects the desired value for each of the plurality of worker rating questions, wherein the values are aggregated to generate the worker rating being a value from 1-5. After answering each of the plurality of worker rating questions, the contractor clicks a submit review button, wherein the worker review is finalized and saved by the back-end system.

The present invention can be applied to any industry and type of workforce. For example, the present invention may be used in providing cleaning services, seasonal workers, temporary accounting services during tax season, or temporary engineering services. While the present invention is described in relation to hiring skilled workers, it may also be utilized for hiring unskilled workers.

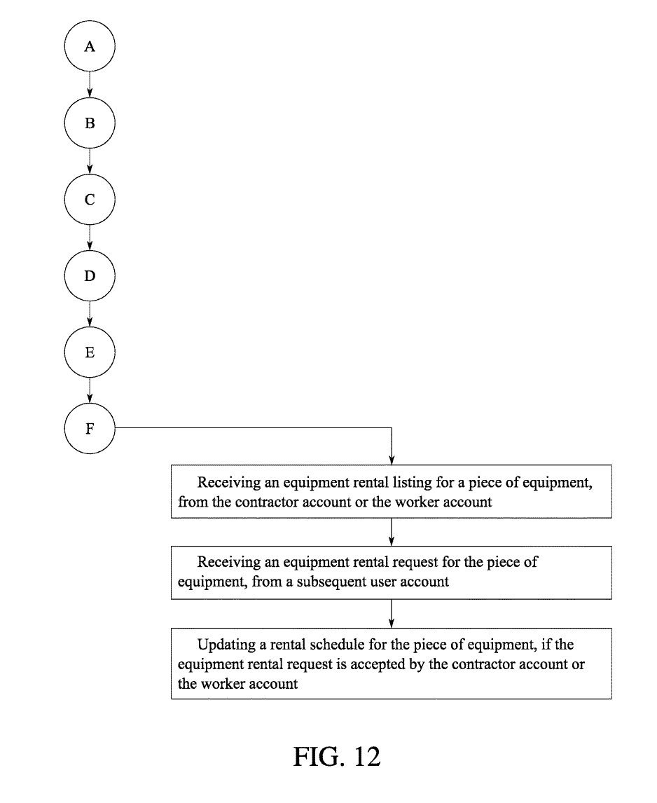

In reference to FIG. 12, for certain industries, the present invention can also be utilized to rent equipment or other belongings. For example, the contractor or the skilled worker may require a certain piece of equipment for the project that is not currently owned. Alternatively, the contractor or the skilled worker may have a piece of equipment that is not currently needed, in which case the contractor or the skilled worker can profit by renting the piece of equipment. The back-end system receives an equipment rental listing for the piece of equipment from either the contractor account or the worker account. The equipment rental listing is then posted by the back-end system, wherein a subsequent user account can submit an equipment rental request for the piece of equipment. The back-end system receives and then processes and sends the equipment rental request to the contractor account or the worker account, wherein the contractor or the skilled worker accepts or denies the equipment rental request. If the equipment rental request is accepted, then a rental schedule for the piece of equipment is updated for the agreed upon rental length. The back-end system is also used to communicate transportation arrangements between the subsequent user account and either the contractor account or the worker account.

Although the invention has been explained in relation to its preferred embodiment, it is to be understood that many other possible modifications and variations can be made without departing from the spirit and scope of the invention as hereinafter claimed.

What is claimed is:

1. A method for employment management by executing computer-executable instructions stored on a non-transitory computer-readable medium, the method comprises the steps of:
receiving available dates, unavailable dates, and a work region from each of a plurality of worker accounts;
indicating the available dates and the unavailable dates on a live worker calendar for each of the plurality of worker accounts;
receiving a worker request from a contractor account;
filtering a plurality of available worker accounts from the plurality of worker accounts according to the available dates and the work region;
receiving, from the contractor account, a contract request for a specific worker account from the plurality of available worker accounts; and
updating a live contractor calendar for the contractor account and the live worker calendar for the specific worker account, if the contract request is accepted through the specific worker account.

2. The method for employment management by executing computer-executable instructions stored on a non-transitory computer-readable medium, the method as claimed in claim 1 further comprises the steps of:
receiving a registration request and worker details for a worker account;
uploading the worker details into a worker database; and
adding the worker account to the plurality of worker accounts.

3. The method for employment management by executing computer-executable instructions stored on a non-transitory computer-readable medium, the method as claimed in claim 1 further comprises the steps of:
receiving a registration request and contractor details for the contractor account; and
uploading the contractor details into a contractor database.

4. The method for employment management by executing computer-executable instructions stored on a non-transitory computer-readable medium, the method as claimed in claim 1 further comprises the steps of:
comparing a project timeline from the worker request to the available dates of each of the plurality of worker accounts in order to select the plurality of available worker accounts.

5. The method for employment management by executing computer-executable instructions stored on a non-transitory computer-readable medium, the method as claimed in claim 1 further comprises the steps of:
comparing a project location from the worker request to the work region of each of the plurality of worker accounts in order to select the plurality of available worker accounts.

6. The method for employment management by executing computer-executable instructions stored on a non-transitory computer-readable medium, the method as claimed in claim 1 further comprises the steps of:
indicating the available dates in a first color on the live worker calendar; and
indicating the unavailable dates in a second color on the live worker calendar.

7. The method for employment management by executing computer-executable instructions stored on a non-transitory computer-readable medium, the method as claimed in claim 1 further comprises the steps of:
temporarily indicating a project timeline from the worker request on the live worker calendar of the specific worker account when the contract request is received; and
permanently indicating the project timeline on the live worker calendar of the specific worker account, if the contract request is accepted through the specific worker account.

8. The method for employment management by executing computer-executable instructions stored on a non-transitory computer-readable medium, the method as claimed in claim 1 further comprises the steps of:
sending a contract notification in response to the contract request, to a phone number associated with the specific worker account.

9. The method for employment management by executing computer-executable instructions stored on a non-transitory computer-readable medium, the method as claimed in claim 1 further comprises the steps of:
sending a contract notification in response to the contract request, to an email address associated with the specific worker account.

10. The method for employment management by executing computer-executable instructions stored on a non-transitory computer-readable medium, the method as claimed in claim 1 further comprises the steps of:
receiving, from the specific worker account, a response to each of a plurality of contractor rating questions corresponding to the contractor account; and
aggregating the response of each of the plurality of contractor rating questions into a contractor rating for the contractor account.

11. The method for employment management by executing computer-executable instructions stored on a non-transitory computer-readable medium, the method as claimed in claim 1 further comprises the steps of:
receiving, from the contractor account, a response to each of a plurality of worker rating questions corresponding to the specific worker account; and
aggregating the response of each of the plurality of worker rating questions into a worker rating for the specific worker account.

12. The method for employment management by executing computer-executable instructions stored on a non-transitory computer-readable medium, the method as claimed in claim 1 further comprises the steps of:
receiving an equipment rental listing for a piece of equipment, from the contractor account;
receiving an equipment rental request for the piece of equipment, from a subsequent user account; and
updating a rental schedule for the piece of equipment, if the equipment rental request is accepted by the contractor account.

13. The method for employment management by executing computer-executable instructions stored on a non-transitory computer-readable medium, the method as claimed in claim 1 further comprises the steps of:
receiving an equipment rental listing for a piece of equipment, from a worker account from the plurality of worker accounts;
receiving an equipment rental request for the piece of equipment, from a subsequent user account; and
updating a rental schedule for the piece of equipment, if the equipment rental request is accepted by the worker account.
